(19) United States
(12) Patent Application Publication
(10) Pub. No.: US 2016/0036131 A1
(43) Pub. Date: Feb. 4, 2016

(54) SLOT ARRAY ANTENNA FOR VEHICLE RADAR

(71) Applicant: Hyunday Motor Company, Seoul (KR)

(72) Inventor: Dong Jin Kim, Seoul (KR)

(21) Appl. No.: 14/533,653

(22) Filed: Nov. 5, 2014

(30) Foreign Application Priority Data
Jul. 31, 2014 (KR) 10-2014-0098402

(51) Int. Cl. H01Q 13/18; H01Q 1/27

(52) U.S. Cl. CPC H01Q 13/18; H01Q 1/27

(57) ABSTRACT

A slot array antenna for a vehicle radar system is provided. The antenna includes a cavity which separates a magnetic field signal applied through a feeding waveguide while maintaining phase and amplitude and which radiates such signals to the each radiating slot. A slot array antenna includes a 2-by-2 unit cell arrangement and a feeding plate member that forms a feeding waveguide. In addition, a first slot plate member includes a coupling slot, a cavity plate member forms a cavity, and a second slot plate member has a plurality of sequentially laminated radiation slots. Further, the cavity includes a partition wall for impedance matching

### CROSS-REFERENCE TO RELATED APPLICATIONS

Pursuant to 35 U.S.C. §119(a), this application claims the benefit of Korean Application No. 10-2014-0098402, filed on Jul. 31, 2014, which is incorporated herein in its entirety.

### BACKGROUND

1. Field of the Invention

The present invention relates to a slot array antenna for a vehicle radar system, more particularly, to a slot array antenna for vehicle radar system which includes a laminated structure, has an increased degree of design freedom due to the repetitive structure of a plurality of unit cells and also is ultra-thin, light-weight, has low-loss characteristics, and also has a wideband characteristic due to a wideband feeding structure.

2. Discussion of the Related Art

Vehicle radar systems are generally disposed in a front part of a vehicle, and are required to be thin and light-weight Losses suffered by such radar systems should be minimal since substantially high frequency signals (e.g., signals of more than several tens of GHz) are generally transmitted and received over fields of constant strength.

The currently-available antenna technology for vehicle radar systems is limited to a patch array antenna, since patch antennas can be implemented as light-weight and thin structures. However, for a patch array antenna, transmission and reception characteristics may be significantly deteriorated due to substantial losses caused by the use of dielectric substrates. In particular, since radar uses high frequency bands, generally greater than several tens of GHz, the efficiency of a patch array antenna for a vehicle is generally less than about 30%. In addition, since patch array antennas use a characteristic feeding structure in a serial way (Series Feeding), and since the frequency band characteristic is narrow, information and data throughput may generally not be increased. Accordingly, a waveguide slot array planar antenna has been proposed.

Since the conventional waveguide slot array planar antenna does not have a structure for implementing impedance matching for the antenna, impedance matching may not be possible.

### SUMMARY

The present invention provides a slot array antenna for a vehicle radar system having a cavity which separates a magnetic field signal applied via a feeding waveguide while maintaining phase and amplitude and which radiates such signals to each radiating slot and which includes a partition wall for impedance matching. The object of the present invention is not limited to the above-mentioned object, and while not mentioned, other objects and advantages of the present invention can be understood by the following description, and will become apparent by the exemplary embodiments of the present invention disclosed herein. Also, it will be seen that the objects and advantages of the present invention can be easily realized by means described in the claims and combinations thereof.

According to the present invention, a slot array antenna for a vehicle radar system comprising: an arrangement of 2-by-2 unit cells; wherein the 2-by-2 unit cells, a feeding plate member that forms a feeding waveguide, a first slot plate member that includes a coupling slot, a cavity plate member that includes a cavity, and a second slot plate member including four radiation slots are sequentially laminated, and the cavity includes a partition wall for impedance matching.

The present invention enables a slot array antenna for a vehicle radar system to have a wideband characteristic while preventing generation of reflected waves. Such reflection is prevented by having a cavity that separates the magnetic field signal applied through a feeding waveguide while maintaining phase and amplitude and by having a partition wall for impedance matching.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary top view of a slot array antenna for a vehicle radar system according to an exemplary embodiment of the present invention;

FIG. 2 is an exemplary side view of an embodiment of a slot array antenna for a vehicle radar system according to an exemplary embodiment of the present invention;

FIG. 3 is an exemplary detailed view of a slot array antenna system for a vehicle radar system according to an exemplary embodiment of the present invention;

FIG. 4 is an exemplary drawing which matches an exploded perspective view and a front view of a 2-by-2 unit cell according to an exemplary embodiment of the present invention;

FIG. 5 is an exemplary drawing which matches a perspective view and a front view of a 2-by-22 unit cell according to an exemplary embodiment of the present invention;

FIG. 6 is an exemplary drawing showing the gain and the efficiency of an antenna which a 2-by-2 unit cell according to the present invention is arranged in an 8-by-8 layout;

FIG. 7 is an exemplary drawing showing the radiation pattern of an antenna having a plurality of 2-by-2 unit cells according to the present invention is arranged in an 8-by-8 layout;

FIG. 8 is an exemplary drawing showing a radiation pattern of an antenna in which a 2-by-2 unit cell according to the present invention is arranged in an 8-by-2 layout; and

FIG. 9 is an exemplary drawing showing a radiation pattern of an antenna in which a plurality of 2-by-2 unit cells according to the present invention is arranged in a 4-by-4 layout.

### DETAILED DESCRIPTION

The foregoing objects, features and advantages will be more apparent through the detailed description as set forth below with reference to the accompanying drawings, and thus those skilled in the art can understand the technical spirit of the present invention. Further, in the following description of the present invention, if it is determined that the detailed description for the known art related to the present invention unnecessarily obscures the gist of the present invention, the detailed description thereof will be omitted. Hereinafter, with reference to the accompanying drawings, exemplary embodiments of the present invention will be described in detail.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”

It will be understood that, although the terms “first”, “second”, “A”, “B”, “(a)”, “(b)”, etc. may be used herein to describe various elements of the present invention, these terms are only used to distinguish one element from another element and essential, order, or sequence of corresponding elements are not limited by these terms.

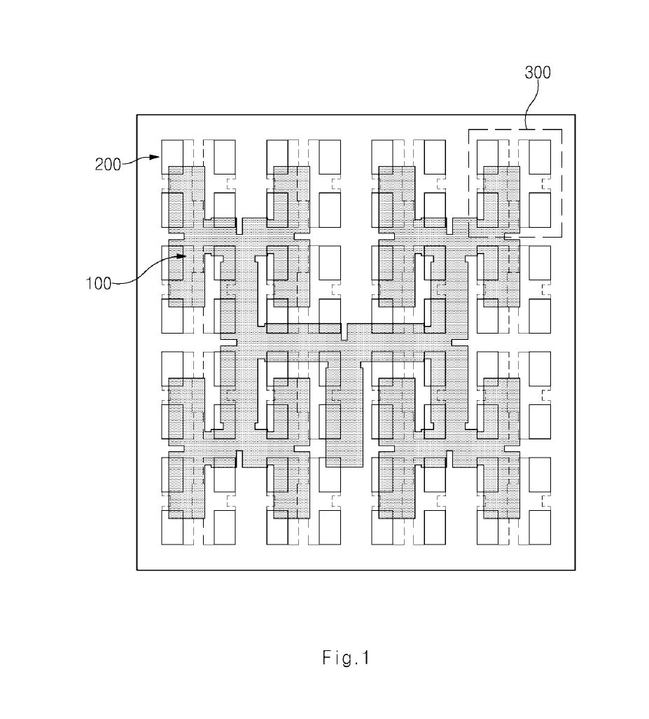

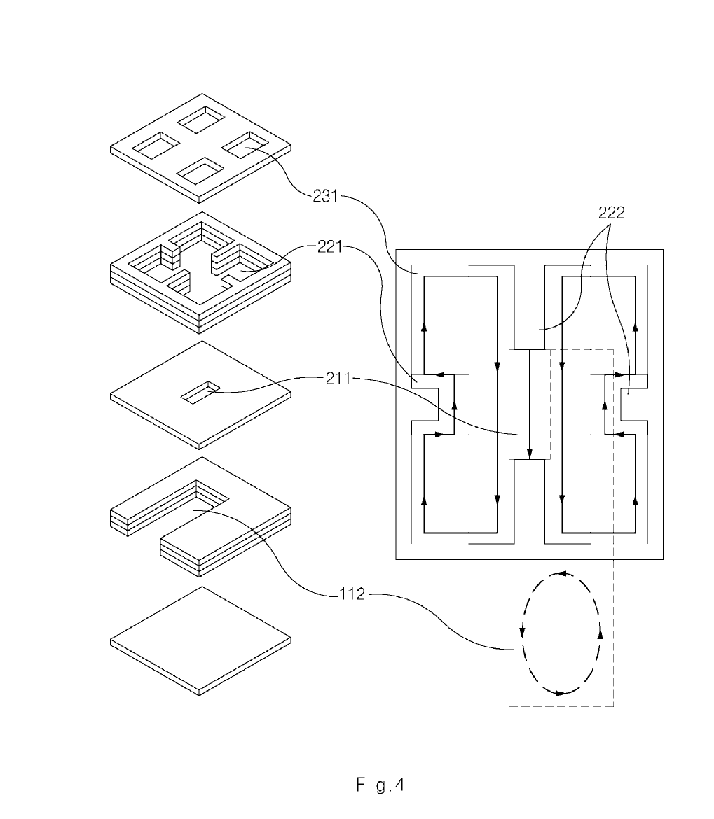

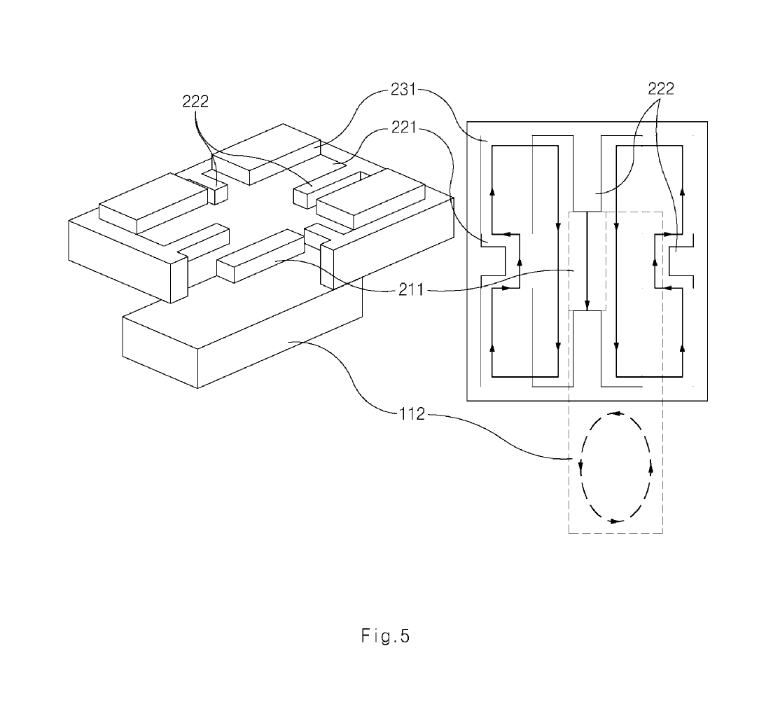

FIG. 1 is an exemplary top view of a slot array antenna for a vehicle radar system according to the present invention. As shown in FIG. 1, a slot array antenna for a vehicle radar system according to the present invention, may include a laminated structure in which a feeding structure 100 is disposed in a first layer and a radiation structure 200 is disposed in a second layer. The feeding structure 100 is shown as the shaded dark portion (gray). In addition, the slot array antenna may be an antenna which may have an array of 2-by-2 unit cells 300. The structure of the 2-by-2 unit cell 300 will be described with reference to FIG. 4 and FIG. 5.

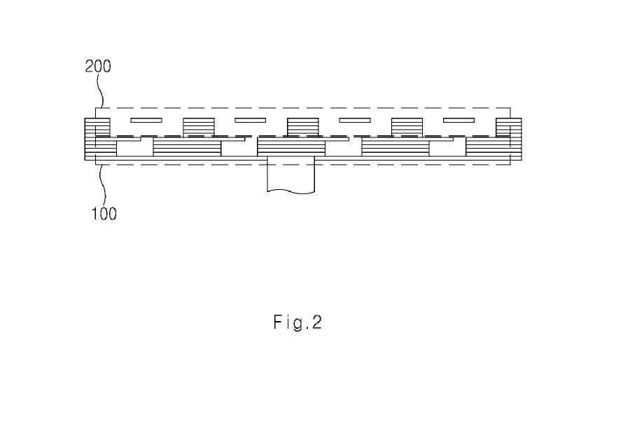

FIG. 2 is an exemplary side view of a slot array antenna for a vehicle radar system according to exemplary embodiments of the present invention. As shown in FIG. 2, in the slot array antenna, a feeding structure 100 may be disposed in a first layer and a radiation structure 200 may be disposed in a second layer. In addition, the feeding structure 100 may include a feeding waveguide.

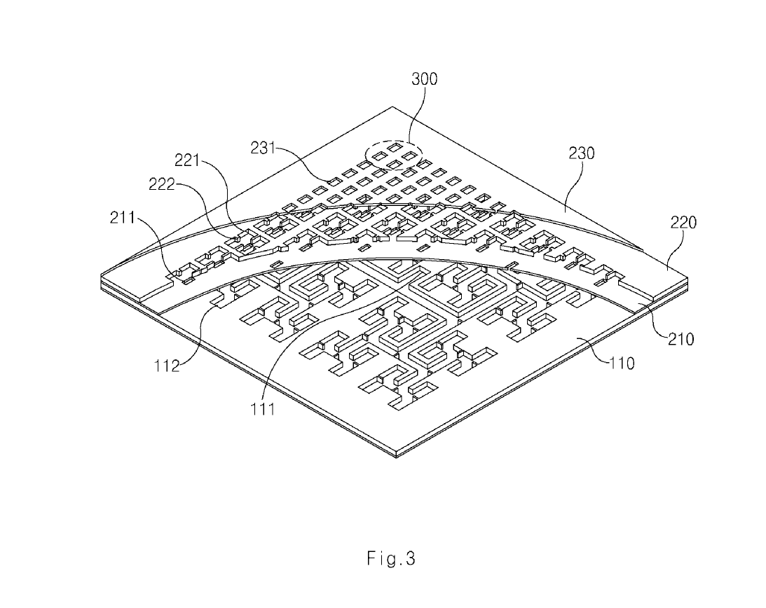

FIG. 3 is an exemplary detailed view of a slot array antenna for a vehicle radar system according to the present invention. As shown in FIG. 3, in the slot array antenna, the feeding structure 100 which may be disposed in a first layer may include a feeding plate member 110, in which a feeding part 111 and a feeding waveguide 122 may be formed, and the radiation structure 200 which may be disposed in a second layer may include a first slot plate member 210 in which a coupling slot 211 may be formed. Also shown are a cavity plate member 220 in which a cavity 221 may be formed and a second slot plate member 230 in which a radiation slot 231 may be formed.

Further, the first slot plate member 210 may be laminated in a lower section of the feeding structure above the feeding plate 110, the cavity plate member 220 may be laminated in a middle section of the feeding structure above the feeding plate 110, and the second slot plate member 230 may be laminated in a upper section of the feeding structure above the feeding plate 110. It should be understood that the terms “upper” and “lower” are used for explanation and the location of the first and second plate members, 210 and 230, respectively, may be in either the upper or lower sections, however their locations relative to the feeding plate 110 may remain unchanged.

The feeding part 111 may connect an antenna to a communication circuit. In other words, the feeding part 111 may receive a magnetic field signal from the communication circuit. The feeding waveguide 112 may distribute the magnetic field signal fed through the feeding part 111 to each cavity 221. The coupling slot 211 may perform coupling with the feeding structure 100. In other words, the coupling slot 211 may transmit the magnetic field signal, which may then be distributed through the feeding waveguide 122 to the cavity 221. The cavity 221 may separate the magnetic field signal applied through the feeding waveguide 122 in the same phase and same amplitude, as illustrated. In particular, the cavity 221 may include a partition wall 222 for impedance matching for the antenna. The radiation slot 231 may radiate the magnetic field signal separated in the same phase and same amplitude by the cavity 221. The distance between the radiating slots may be fixed to about 0.86.

FIG. 4 is an exemplary drawing which matches a detailed view and a front view of a 2-by-2 unit cell according to the present invention. FIG. 5 is an exemplary drawing which matches a view and a front view of a 2-by-2 unit cell according to the present invention. In FIG. 4 and FIG. 5, one side of the flow (arrow) of the magnetic field in the cavity is clockwise, and the other side is counterclockwise relative to coupling slot 211. Additionally, the partition wall 222 may be disposed in the substantial center of the top plane, the substantial center of the bottom plane, the substantial center of the left side and the substantial center of the right side of the square cavity 221. The partition wall lengths located in the center of the top plane and the center of the bottom plane are may be about the same, and also, the partition wall lengths located in the center of the left side and the center of the right side may have about the same dimensions.

Further, the partition wall lengths located in the substantial center of the top plane and the substantial center of the bottom plane may be longer dimensions than the partition wall lengths located in the substantial center of the left side and the substantial center of the right side. On the other hand, the slot array antenna for a vehicle radar system according to exemplary embodiments of the present invention may include a conductor (copper, etc.) and thus the losses due to the material may be reduced compared to the losses associated with a patch array antenna made from a dielectric. Further, the slot array antenna for a vehicle radar system according to exemplary embodiments of the present invention may have a 2-by-2 unit cells arrangement 300. The size of the antenna may be determined by adjusting the number of unit cells 300 according to the needs of the designer.

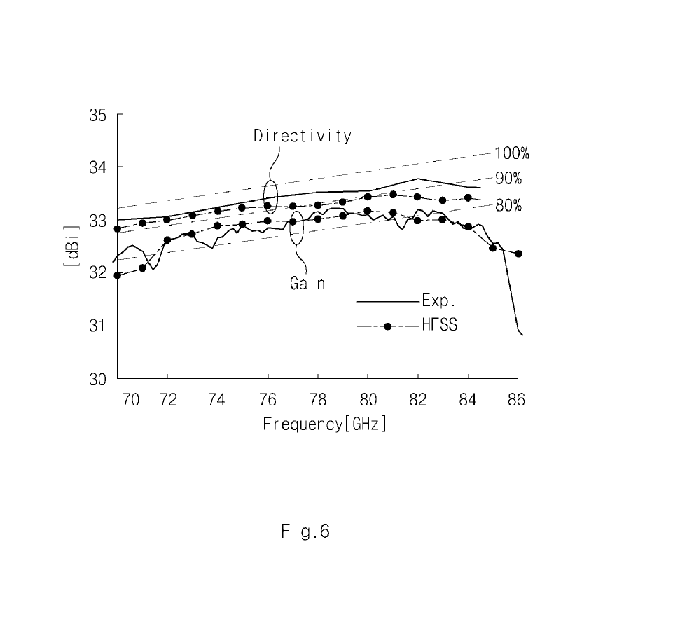

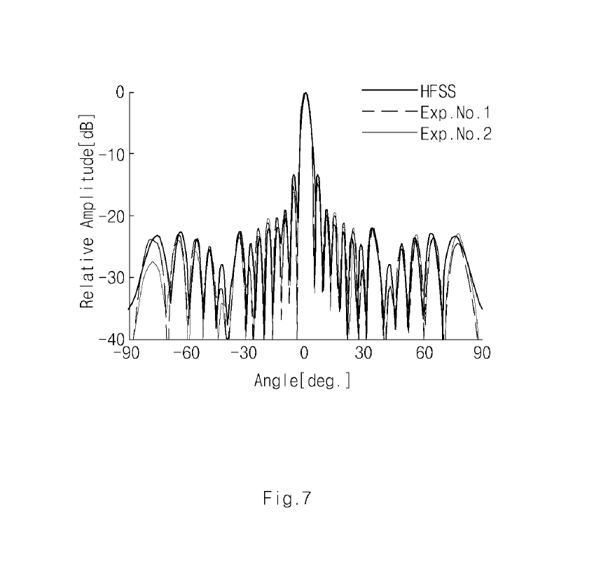

As an example, the antenna which having unit cells arranged in an 8-by-8 layout may have an increased gain characteristic, (e.g., greater than about 33 dBi in the 70 GHz band). Accordingly, abeam width in the H plane may be about 3.5°, and the efficiency of the antenna may be about 90% as shown in FIG. 6. The antenna may be an ultra-thin type of antenna, having a width of about 54 mm, a length of about 54 mm, a thickness of about 1.6 mm. In addition, a radiation pattern associated with such an antenna may have a ‘Pencil Beam’ pattern, as shown in FIG. 7, and may be suitable beam pattern for a vehicle radar system.

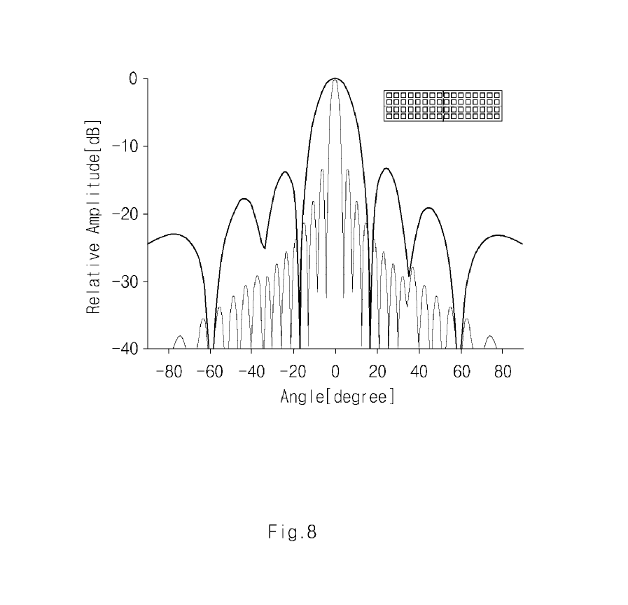

FIG. 8 is an exemplary drawing showing a radiation pattern for an antenna according to exemplary embodiments of the present invention which may include a plurality of 2-by-2 unit cells arranged in an 8-by-2 layout. As shown in FIG. 8, the size of an antenna, having a plurality of 2-by-2 unit cells arranged in an 8-by-2 layout, may be about 53.7 mm wide by about 6.7 mm long. Such an antenna may have a gain of more than about 27 dBi at 70 GHz, and may have a beam width in the H plane of about 7°.

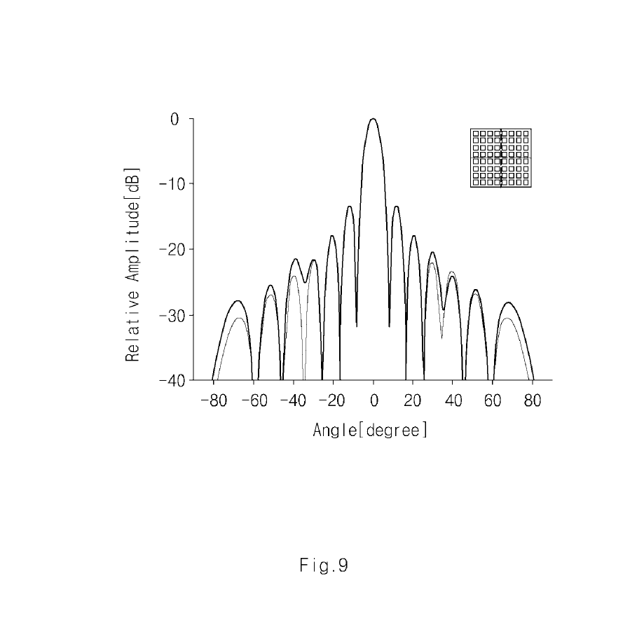

FIG. 9 is an exemplary drawing showing a radiation pattern for an antenna according to exemplary embodiments of the present invention which may include a plurality of 2-by-2 unit cells arranged in a 4-by-4 layout. As shown in FIG. 9, the size of antenna, having a plurality of 2-by-2 unit cells arranged in a 4-by-4 layout, may be about 26.8 mm wide and about 26.8 mm long. Such an antenna may have a gain of more than about 27 dBi at 70 GHz, and a beam width in the H plane of about 14°.

As the above described, the present invention is not limited to the aforementioned exemplary embodiments and accompany drawings, since replacements, various modifications, and changes may be made without departing from the technical spirit of the present invention by those skilled in the art.

What is claimed is:

1. A slot array antenna for a vehicle radar system comprising:
an arrangement of 2-by-2 unit cells;
wherein the 2-by-2 unit cells, a feeding plate member that forms a feeding waveguide, a first slot plate member that includes a coupling slot, a cavity plate member that includes a cavity, and a second slot plate member including four radiation slots are sequentially laminated, and the cavity includes a partition wall for impedance matching.

2. A slot array antenna for a vehicle radar system according to claim 1, wherein the cavity is substantially square.

3. A slot array antenna for a vehicle radar system according to claim 2, wherein the partition wall is disposed adjacent each of a substantial center of a top plane, a substantial center of a bottom plane, a substantial center of a left side and a substantial center of a right side of the cavity.

4. A slot array antenna for a vehicle radar system according to claim 3, wherein the partition wall lengths located in the substantial center of the top plane and the substantial center of the bottom plane are about the same, and the partition wall lengths located in the substantial center of the left side and the substantial center of the right side are about the same.

5. A slot array antenna for a vehicle radar system according to claim 4, wherein in the partition wall, the partition wall length located in the substantial center of the top plane is greater than the partition wall length located in the substantial center of the left side.

6. A slot array antenna for a vehicle radar system according to claim 1, wherein a distance between the radiating slots is about 0.86.

7. A slot array antenna for a vehicle radar system according to claim 1, wherein the 2-by-2 of unit cells arranged in an 8-by-8 layout.

8. A slot array antenna for a vehicle radar system according to claim 2, wherein in a magnetic field in the cavity, one side is clockwise, and the other side is counterclockwise by the reference of the coupling slot of a rectangle located in a substantial center of the cavity.

9. A slot array antenna for a vehicle radar system according to claim 1, wherein the 2-by-2 unit cells arranged in an 8-by-2 layout.

10. A slot array antenna for a vehicle radar system according to claim 1, wherein the 2-by-2 of unit cells arranged in a 4-by-4 layout.
